(19) United States
(12) Patent Application Publication
(10) Pub. No.: US 2023/0241925 A1
(43) Pub. Date: Aug. 3, 2023

(54) Tire for an Agricultural Vehicle Comprising an Improved Tread

(71) Applicant: COMPAGNIE GENERALE DES ETABLISSEMENTS MICHELIN, Clermont-Ferrand (FR)

(72) Inventors: Frédéric PERRIN, Clermont-Ferrand Cedex 9 (FR); David DEAN, Clermont-Ferrand Cedex 9 (FR); Jean-Michel VACHERAND, Clermont-Ferrand Cedex 9 (FR); Maxime PRAS, Clermont-Ferrand Cedex 9 (FR)

(21) Appl. No.: 18/015,888

(22) PCT Filed: Jul. 5, 2021
(86) PCT No.: PCT/FR2021/051222

§ 371 Date: Jan. 12, 2023

(30) Foreign Application Priority Data
Jul. 16, 2020 (FR) FR2007455

(51) Int. Cl. B60C 11/03

(52) U.S. Cl. CPC B60C 11/0311; B60C 2011/0313; B60C 2200/08

(57) ABSTRACT

A tire for an agricultural vehicle, and in particular its tread, which aims to increase its traction capability in the field on loose ground. The tire having a nominal section width L, a central tread portion (211), centred on an equatorial plane (E) of the tire and having an axial width L1 at least equal to 0.15*L and at most equal to 0.35*L, has circumferentially distributed tread pattern elements (221), which are separated in pairs by transverse voids (231) forming an angle at least equal to 30° with the circumferential direction (XX′), and the central tread portion (211) has a local volumetric void ratio TEVL1, defined as being the ratio between the volume VC1 of the transverse voids (231) and the total volume V1 of the central tread portion (21), between the bearing surface (24) and the tread surface (25), is at most equal to 15%.

The present invention relates to a tire for an agricultural vehicle, such as an agricultural tractor or an agri-industrial vehicle, and relates more particularly to the tread thereof.

The dimensional specifications (section width, overall diameter, diameter and width of the mounting rim) and the use conditions (load, speed, pressure) of a tire for an agricultural vehicle are defined in standards, for example the standard of the ETRTO, or “European Tire and Rim Technical Organisation”, in its “Standards Manual-2018”, in the section devoted to “Agricultural equipment tires”. By way of example, a radial tire for a driven wheel of an agricultural tractor is intended to be mounted on a rim of which the diameter is generally comprised between 16 inches and 46 inches, or even 54 inches. It is intended to be run on an agricultural tractor of which the power is comprised between 50 CV and more than 250 CV (up to 550 CV) and able to run at up to 65 km/h. For this type of tire, the minimum recommended inflation pressure corresponding to the indicated loading capacity is usually at most equal to 400 kPa, but may drop as low as 240 kPa for an “IF”, or “Improved Flexion”, tire, or even 160 kPa for a “VF”, or “Very high Flexion”, tire.

Like any tire, a tire for an agricultural vehicle comprises a tread which is intended to come into contact with the ground via a tread surface—a surface making contact with firm ground—and the two axial ends of which are connected via two sidewalls to two beads that provide the mechanical connection between the tire and the rim on which it is intended to be mounted.

In the following text, the circumferential (or longitudinal), axial (or transverse) and radial directions denote a direction tangential to the tread surface and oriented in the direction of rotation of the tire, a direction parallel to the axis of rotation of the tire, and a direction perpendicular to the axis of rotation of the tire, respectively. A radial (or meridian) plane is defined by a radial direction and the axial direction and contains the axis of rotation of the tire. A circumferential plane is defined by a radial direction and a circumferential direction and is therefore perpendicular to the axis of rotation of the tire. The circumferential plane that passes through the middle of the tread is known as the equatorial plane.

The tread of a tire for an agricultural vehicle generally comprises a plurality of raised elements, known as tread pattern elements, which extend radially outwards from a bearing surface as far as the tread surface and are separated from one another by voids.

The proportion of voids is usually quantified by an overall volumetric void ratio TEV, defined as the ratio between the volume VC of voids and the total volume V of the tread assumed to be free of voids, corresponding to the geometric volume delimited by the bearing surface and the tread surface. Since the tread surface varies depending on the degree of wearing of the tread, the overall volumetric void ratio TEV will generally, although not necessarily, vary with the degree of wear. Thus, the overall volumetric void ratio TEV may be defined for when the tire is in a new state or is in a given state of wear. For example, a tire for a driven wheel of an agricultural tractor when in the new state has an overall volumetric void ratio TEV that is generally at least equal to 50% and usually at least equal to 60%. In the following text, the expression “overall volumetric void ratio TEV” implicitly means “overall volumetric void ratio TEV when the tire is in the new state”.

A local volumetric void ratio TEVL may also be defined for any tread portion that extends circumferentially over the entire circumference of the tire and extends axially from a first circumferential plane to a second circumferential plane, the distance between these two circumferential planes representing the axial width, referred to more simply as width, of the tread portion. The local volumetric void ratio TEVL is defined as being the ratio between the volume of voids VCL and the total volume VL of the tread portion assumed to be free of voids, which corresponds to the geometric volume delimited by the bearing surface, the tread surface, and the two circumferential planes. Like the overall volumetric void ratio TEV, the local volumetric void ratio TEVL may be defined for the tire when it is in a new state or is in a given state of wear. In the following text, the expression “local volumetric void ratio TEVL” implicitly means “local volumetric void ratio TEVL when the tire is in the new state”.

Each tread pattern element can be geometrically characterized by a radial height H in a radial direction, an axial width A in an axial direction, and a circumferential length B in a circumferential direction. These three dimensions H, A and B are mean values, in the knowledge that these can vary depending on the measurement points selected on the tread pattern element. As regards the axial width A and the circumferential length B, they may increase from the tread surface to the bearing surface at the void bottom, because of the presence of tapers. As regards the radial height H, for a radial tire for a driven wheel of an agricultural tractor, the radial height H of a tread pattern element is generally at least equal to 50 mm and more generally at least equal to 60 mm From these three dimensions H, A and B, it is possible to define, for a given tread pattern element, a circumferential slenderness H/B, an axial slenderness H/A and a surface-area aspect ratio B/A.

A tread for an agricultural vehicle usually comprises tread pattern elements in the form of lugs. A lug generally has an elongate shape that is parallelepipedal overall, is continuous or discontinuous, and is made up of at least one rectilinear or curvilinear portion. A lug is separated from the adjacent lugs by voids or furrows. A lug extends axially from a median zone of the tread to the axial ends or shoulders thereof. A lug comprises a contact face, positioned in the tread surface and intended to come fully into contact with the ground, a leading face that intersects the tread surface and the arris of intersection therewith of which is intended to be first part to come into contact with the ground, a trailing face that intersects the tread surface and the arris of intersection therewith of which is intended to be last part to come into contact with the ground, and two lateral faces.

The lugs are distributed circumferentially with a spacing that is constant or variable and are generally disposed on each side of the equatorial plane of the tire so as to form a V-shaped pattern, the tip of the V-shaped pattern (or chevron pattern) being intended to be the first part to enter the contact patch in which contact is made with the ground. The lugs generally exhibit symmetry with respect to the equatorial plane of the tire, usually with a circumferential offset between the two rows of lugs, obtained by one half of the tread being rotated about the axis of the tire with respect to the other half of the tread.

A radial tire for an agricultural vehicle further comprises a reinforcement made up of a crown reinforcement radially on the inside of the tread, and a carcass reinforcement radially on the inside of the crown reinforcement.

The carcass reinforcement of a radial tire for an agricultural vehicle comprises at least one carcass layer connecting the two beads to one another. The reinforcers of a carcass layer are substantially mutually parallel and form an angle of between 75° and 105°, preferably between 85° and 95°, with the circumferential direction. A carcass layer comprises reinforcers, usually textile reinforcers, that are coated with a polymer material of the elastomer or elastomeric type, referred to as coating compound.

The crown reinforcement of a radial tire for an agricultural vehicle comprises a superposition of circumferentially extending crown layers, radially on the outside of the carcass reinforcement. Each crown layer is made up of reinforcers that are coated in an elastomer compound and are mutually parallel. When the crown layer reinforcers form an angle of less than 10° with the circumferential direction, they are referred to as circumferential, or substantially circumferential, and perform a hooping function that limits the radial deformations of the tire. When the crown layer reinforcers form an angle at least equal to 10° and usually at most equal to 30° with the circumferential direction, they are referred to as angled reinforcers, and have a function of reacting the transverse loads, parallel to the axial direction, that are applied to the tire. The crown layer reinforcers may be made up of textile-type polymer materials, such as a polyester, for example a polyethylene terephthalate (PET), an aliphatic polyamide, for example a nylon, an aromatic polyamide, for example aramid, or rayon, or may be made up of metal materials such as steel.

A tire for an agricultural vehicle is intended to run over various types of ground such as the more or less compact soil of the fields, unmade tracks providing access to the fields, and the tarmacked surfaces of roads. Bearing in mind the diversity of use, in the field and on the road, a tire for an agricultural vehicle needs to offer a performance compromise between traction in the field on loose ground, resistance to chunking, resistance to wear on the road, resistance to forward travel, and vibrational comfort on the road, this list not being exhaustive.

One essential problem in the use of a tire in the field is that of limiting, as far as possible, the extent to which the soil is compacted by the tire, as this is liable to hamper crop growth.

This is why, in the field of agriculture, low-pressure, and therefore high-flexion, tires have been developed. The ETRTO standard thus makes a distinction between IF (Improved Flexion) tires, which have a minimum recommended inflation pressure generally equal to 240 kPa, and VF (Very high Flexion) tires, which have a minimum recommended inflation pressure generally equal to 160 kPa. According to that standard, by comparison with a standard tire, an IF tire has a 20% higher load-bearing capacity and a VF tire has a 40% higher load-bearing capacity, for an inflation pressure equal to 160 kPa.

However, the use of low-pressure tires has a negative impact on the handling in the field. Thus, the lowering of the inflation pressure has led to a reduction in the transverse and cornering stiffnesses of the tire, thus reducing the transverse thrust of the tire and therefore resulting in inferior handling under transverse loads.

One solution for re-establishing the correct transverse thrust has been to stiffen the crown reinforcement of the tire transversely, by replacing the crown layers having textile reinforcers with crown layers having metal reinforcers. Thus, for example, a crown reinforcement comprising 6 crown layers with textile reinforcers of rayon type has been replaced with a crown reinforcement comprising 2 crown layers with reinforcers made of steel. Document EP 2934917 thus describes an IF tire comprising a crown reinforcement comprising at least two crown layers having metal reinforcers, which is combined with a carcass reinforcement comprising at least two carcass layers having textile reinforcers.

The inventors have then set themselves the objective of increasing the traction capability in the field on loose ground of a tire for an agricultural vehicle in general, and in particular that of a tire for an agricultural vehicle, comprising a crown reinforcement with metal reinforcers and/or operating at low pressure, such as an IF (Improved Flexion) tire or a VF (Very high Flexion) tire.

This objective has been achieved, according to the invention, by a tire for an agricultural vehicle, having a nominal section width L and comprising, radially from the outside to the inside, a tread and a crown reinforcement:
the tread comprising tread pattern elements, which are separated from one another by voids and extend radially outwards from a bearing surface to a tread surface,
the tread having an overall volumetric void ratio TEV, defined as being the ratio between the volume VC of voids and the total volume V of the tread assumed to be free of voids, comprised between the bearing surface and the tread surface,
each tread pattern element having a circumferential slenderness HB at most equal to 1.5, H being a mean radial height between the bearing surface and the tread surface at least equal to 20 mm, and B being a mean circumferential length,
the tread comprising a central portion, centred on an equatorial plane of the tire and having an axial width L1 at least equal to 0.15*L and at most equal to 0.35*L, and two intermediate portions, each of which continues the central portion axially outwards to an axial distance D2 equal to 0.3*L, measured from the equatorial plane,
the central portion and each intermediate portion comprising circumferentially distributed tread pattern elements, which are separated in pairs by transverse voids forming an angle at least equal to 30° with a circumferential direction of the tire,
the crown reinforcement comprising at least two crown layers, each of which comprises mutually parallel reinforcers that are coated with an elastomeric material, are crossed from one layer to the next, and form an angle at least equal to 10° with the circumferential direction,
the central portion having a local volumetric void ratio TEVL1, defined as being the ratio between the volume VC1 of the transverse voids and the total volume V1 of said central portion, comprised between the bearing surface and the tread surface, at most equal to 15%.

According to a first feature of the invention, the tread comprises tread pattern elements having a circumferential slenderness H/B at most equal to 1.5, H being a mean radial height between the bearing surface and the tread surface at least equal to 20 mm, and B being a mean circumferential length. For a given tread pattern element, the radial height between the bearing surface and the tread surface is substantially constant, and therefore the mean radial height H is equal to this substantially constant radial height. By contrast, the circumferential length of a tread pattern element can vary substantially depending on the depth at which it is measured, because of the inclination of the front (or leading) and rear (or trailing) faces of the tread pattern element, in the running direction; hence the need to define a mean circumferential length B. The circumferential slenderness H/B, which geometrically characterizes the circumferential stiffness of the tread pattern element, is not necessarily constant and can vary between two tread pattern elements.

According to a second feature of the invention, the tread moreover comprises a central portion, centred on an equatorial plane of the tire and having an axial width L1 at least equal to 0.15*L and at most equal to 0.35*L, and two intermediate portions, each of which continues the central portion axially outwards to an axial distance D2 equal to 0.3*L, measured from the equatorial plane. The nominal section L of a tire is the “design section width” defined in the ETRTO standard.

In addition, according to a third feature of the invention, the central portion and each intermediate portion comprise circumferentially distributed tread pattern elements, which are separated in pairs by transverse voids forming an angle at least equal to 30° with a circumferential direction of the tire. These voids are described as transverse inasmuch as their direction forms a sufficiently large angle with the circumferential direction, and they therefore cannot be described as circumferential or longitudinal. In other words, their direction varies between an oblique position and a transverse position, parallel to the axis of rotation of the tire. By definition, the angle formed by the voids is the angle formed by their mean surface, which is generally made up of a plane perpendicular to the tread surface. If this mean surface is made up of a succession of planes, each of these planes forms an angle at least equal to 30°.

According to a fourth feature of the invention, the crown reinforcement comprises at least two crown layers, each of which comprises mutually parallel reinforcers that are coated with an elastomeric material, are crossed from one layer to the next, and form an angle at least equal to 10° with the circumferential direction.

According to a fifth and last feature of the invention, the central portion has a local volumetric void ratio TEVL1 at most equal to 15%, that is to say a small volumetric void ratio which indicates the presence of a small void volume.

The combination of these features ensures in particular, for the central portion of the tread, a high degree of circumferential stiffness, owing to its small volumetric void ratio and a limited circumferential slenderness for the tread pattern elements, and also facilitated circumferential flattening when entering the contact patch, owing to the presence of transverse voids which act as hinges; hence an increase in the traction capability. This is because a divided central section made up of blocks separated by transverse voids has better circumferential flattening than a continuous central portion made up of at least one continuous rib without transverse voids.

Advantageously, the transverse voids of the central tread portion form an angle at least equal to 60° with the circumferential direction of the tire. An angle at least equal to 60° is characteristic of a substantially transverse void, which acts as a substantially transverse hinge that even further facilitates the circumferential flattening of the tread in its central portion.

With preference, the transverse voids of the central tread portion are transverse sipes that able to close when they enter the contact patch in which contact is made with the ground when the tire is running The transverse sipes are transverse voids having a very small width, since they are able to close when they enter the contact patch. More specifically, at the entrance and exit of the contact patch, these sipes are open and facilitate the circumferential flattening of the tread in these areas. In the contact patch, these sipes close and create a continuous rib having a greater degree of circumferential stiffness than that obtained with transverse voids that remain open. The ability of the transverse sipes to close when they enter the contact patch is defined on a tire subjected to pressure and load conditions as defined by the ETRTO standard.

Advantageously, the transverse voids of each intermediate portion form an angle at least equal to 60° with the circumferential direction. An angle at least equal to 60° is characteristic of a substantially transverse void, which acts as a substantially transverse hinge that even further facilitates the circumferential flattening of the tread in its intermediate portions.

According to a preferred embodiment, with each tread pattern element of the central portion having a mean radial height H1, a mean circumferential length B1, and a circumferential slenderness H1/B1, and each tread pattern element of each intermediate portion having a mean radial height H2, a mean circumferential length B2, and a circumferential slenderness H2/B2, the circumferential slenderness H1/B1 is strictly greater than the circumferential slenderness H2/B2. In this embodiment, there is therefore a circumferential slenderness differential between the tread pattern elements of the central portion and those of each intermediate portion. A circumferential slenderness H1/B1 of a tread pattern element in the central portion that is strictly greater than the circumferential slenderness H2/B2 of a tread pattern element means that the degree of circumferential stiffness of a tread pattern element of the central portion is less than that of a tread pattern element of the intermediate portions. A relatively high degree of circumferential stiffness of the tread pattern elements of an intermediate portion advantageously ensures a traction capability of the tire when it is running in the field on relatively cohesive ground, for example straw stubble. It should be noted that the circumferential slenderness defining this circumferential stiffness results from a compromise between the traction capability in the field on dry ground, the traction capability in the field on waterlogged ground, obtained by a volumetric void ratio adapted to each intermediate portion, and the service life of the tread, obtained by a sufficient mean radial height H2 of a tread pattern element with an intermediate portion.

According to a preferred variant of the preferred embodiment described above, the circumferential slenderness H2/B2 of each tread pattern element (222) of each intermediate portion (212) is at most equal to 0.6. This condition means that the circumferential stiffness of a tread pattern element of an intermediate portion that is necessary for the tire to have sufficient traction capability when it is running in the field on relatively cohesive ground is obtained for a tread pattern element that is quite elongate in the circumferential direction, with a mean radial height H2 at most equal to 60% of the mean circumferential length B2.

With further preference, a median tread portion that is centred on the equatorial plane of the tire and has an axial width L2 equal to 2*D2=0.40*L has a local volumetric void ratio TEVL2, defined as being the ratio between the volume VC2 of the voids and the total volume V2 of said median tread portion, comprised between the bearing surface and the tread surface, at most equal to 45%. In other words, the volumetric void ratio TEVL2, determined over a median portion having a width L2 equal to 40% of the nominal section width L of the tire and being made up of the central portion and the two intermediate portions described above, is greater than the volumetric void ratio TEVL1 of the central portion, without, however, exceeding 45%. Consequently, the void volume increases with increasing distance from the equatorial plane of the tire, this making it possible in particular to ensure satisfactory traction on wet ground with low cohesion.

According to a first embodiment variant, the tread comprises exclusively transverse voids. Consequently, the tread does not comprise any circumferential voids.

According to a second embodiment variant, the central tread portion is axially delimited on either side by circumferential voids. Circumferential void is understood to mean a void which is either strictly circumferential, or oblique with an angle of inclination at most equal to 45° with respect to the circumferential direction.

Advantageously, each tread pattern element has a mean radial height H at most equal to 55 mm Above this value, the circumferential slenderness H/B of a tread pattern element runs the risk of being above 0.8. As a consequence, the flexural cornering stiffness and shear stiffness, in the circumferential direction, of each tread pattern element become too low to ensure sufficient overall circumferential stiffness for the desired level of traction, in particular in the central portion of the tread. Furthermore, an excessively large radial height adversely affects the level of heat at the crown of the tire, and therefore its endurance.

Further advantageously, the tread has an overall volumetric void ratio TEV at most equal to 56%. Above this value of overall volumetric void ratio TEV, the void volume becomes too high. Correspondingly, the volume of material becomes too low to ensure sufficient service life in terms of wear.

In one particular embodiment of transverse voids, at least some of the transverse voids comprise at least one chamfer which opens out on the tread surface with the formation of an angle D at least equal to 30° and at most equal to 70° with a radial direction and has a radial height C at least equal to 3 mm and at most equal to 10 mm. Often, all the transverse voids comprise at least one chamfer. According to a first variant, all the transverse voids comprise a single chamfer. According to a second variant, all the transverse voids comprise two facing chamfers. The presence of chamfers contributes to significantly improving the traction of the tread.

According to a preferential embodiment of the crown reinforcement of the tire, the crown reinforcement comprises crown layers comprising metal reinforcers, preferably at most two crown layers comprising metal reinforcers. The presence of metal reinforcers makes it possible to obtain the desired crown stiffness with a limited number of crown layers, implying a limited crown thickness. This results in a lower degree of flexural stiffness of the crown than for a conventional crown of the prior art, thereby facilitating the flattening of the tire. Thus, the area of the contact patch in which contact is made with the ground is increased, thereby, on the one hand, reducing the ground pressure and therefore the compaction of the ground, and, on the other hand, increasing the traction capability.

In a first preferential tire sector, the tire for an agricultural vehicle is an “IF”, or “Improved Flexion”, tire within the meaning of the standard of the “ETRTO”, or “European Tire and Rim Technical Organisation”, in its “Standards Manual-2018”, in the section devoted to “Agricultural equipment tires”, having a load-bearing capacity 20% greater than that of a standard tire for the same pressure.

In a second preferential tire sector, the tire for an agricultural vehicle is a “VF”, or “Very high Flexion”, tire within the meaning of the standard of the “ETRTO”, or “European Tire and Rim Technical Organisation”, in its “Standards Manual-2018”, in the section devoted to “Agricultural equipment tires”, having a load-bearing capacity 40% greater than that of a standard tire for the same pressure.

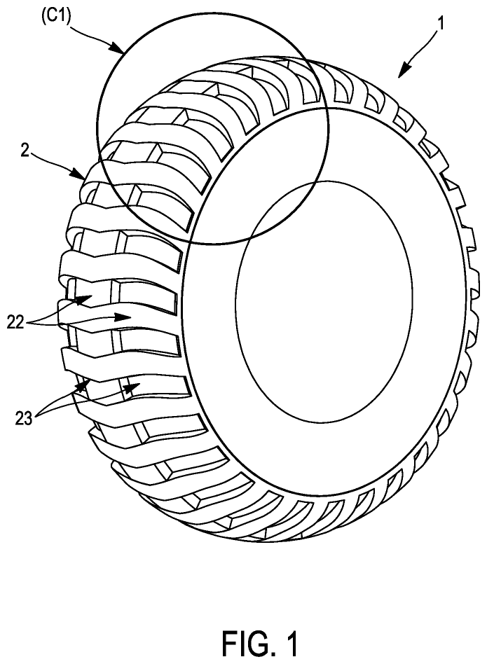

The features of the invention are illustrated by the schematic FIGS. 1 to 12, which are not drawn to scale:

FIG. 1: Perspective overview of a tire for an agricultural vehicle according to a first embodiment variant of the invention.

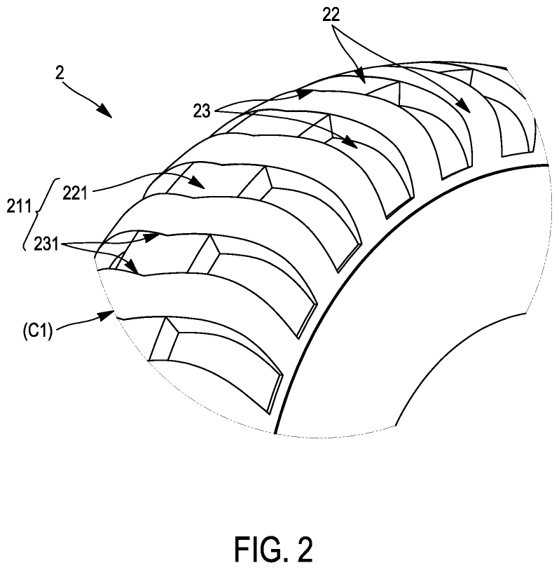

FIG. 2: Detailed perspective view of the tread of a tire for an agricultural vehicle according to the first embodiment variant of the invention (detail C1 from FIG. 1).

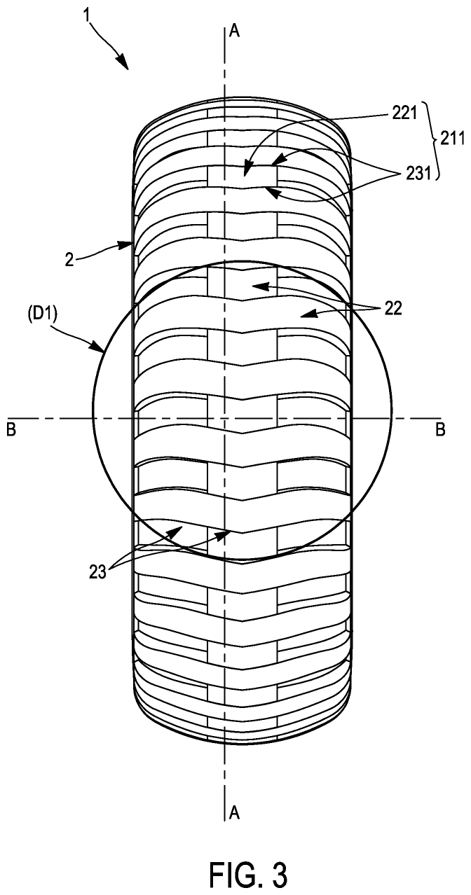

FIG. 3: Face-on overview of a tire for an agricultural vehicle according to the first embodiment variant of the invention.

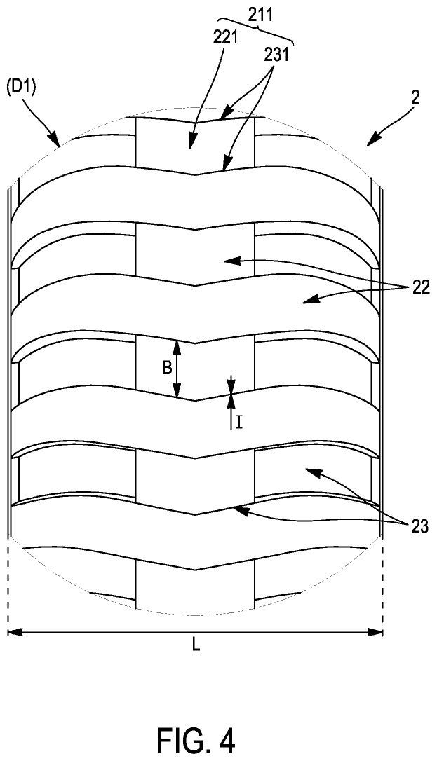

FIG. 4: Detailed face-on view of the tread of a tire for an agricultural vehicle according to the first embodiment variant of the invention (detail D1 in FIG. 3).

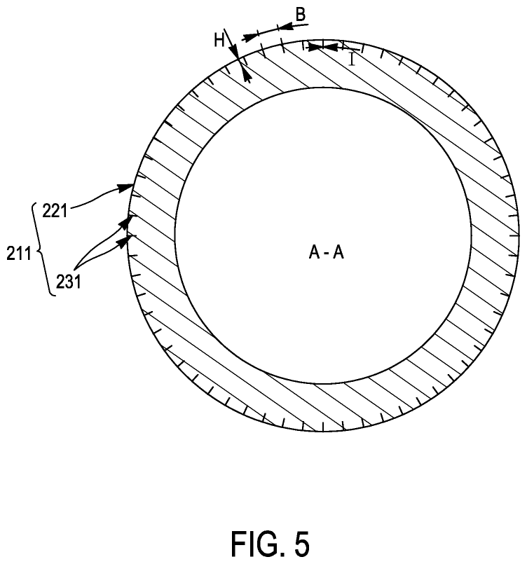

FIG. 5: Circumferential section of the tread of a tire for an agricultural vehicle according to the first embodiment variant of the invention (section A-A from FIG. 3).

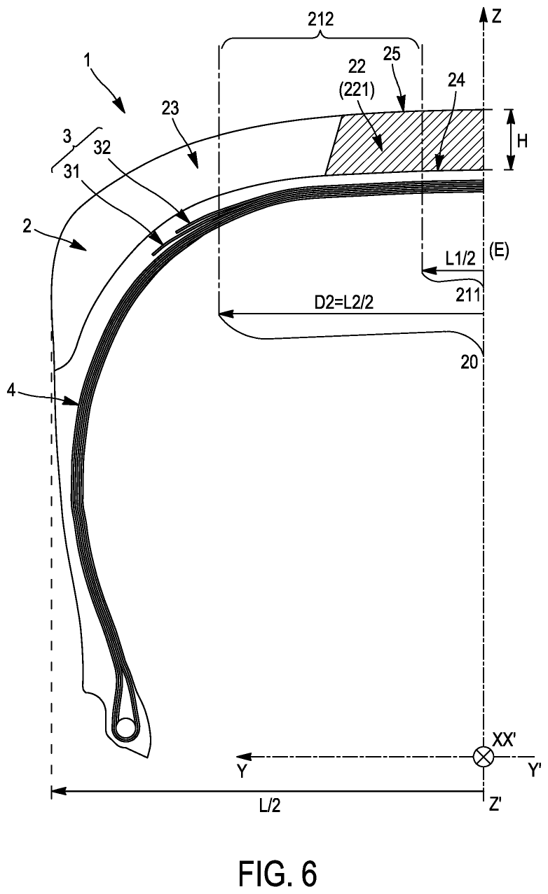

FIG. 6: Meridian half-section of a tire for an agricultural vehicle according to the invention (section B-B from FIG. 3).

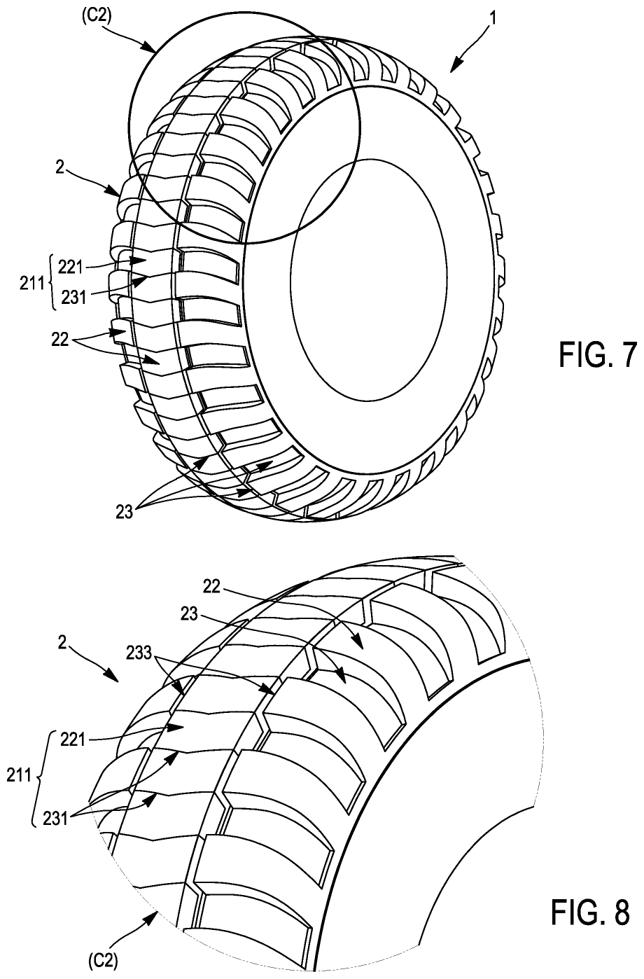

FIG. 7: Perspective overview of a tire for an agricultural vehicle according to a second embodiment variant of the invention.

FIG. 8: Detailed perspective view of the tread of a tire for an agricultural vehicle according to the second embodiment variant of the invention (detail C2 from FIG. 7).

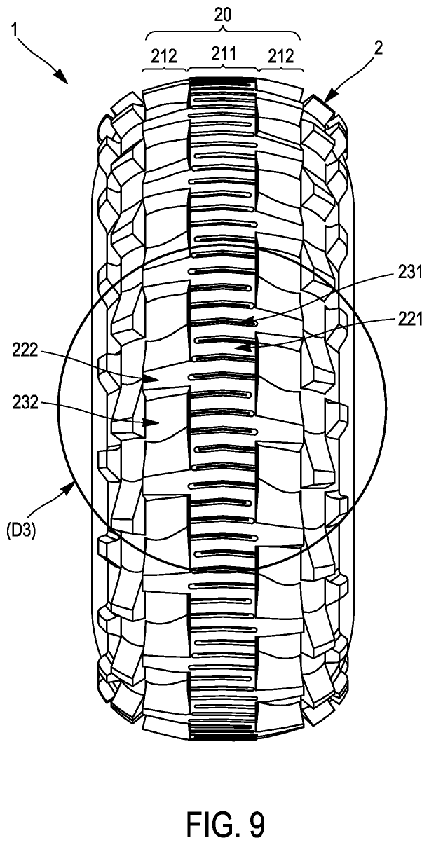

FIG. 9: Face-on overview of a tire for an agricultural vehicle according to a third embodiment variant of the invention.

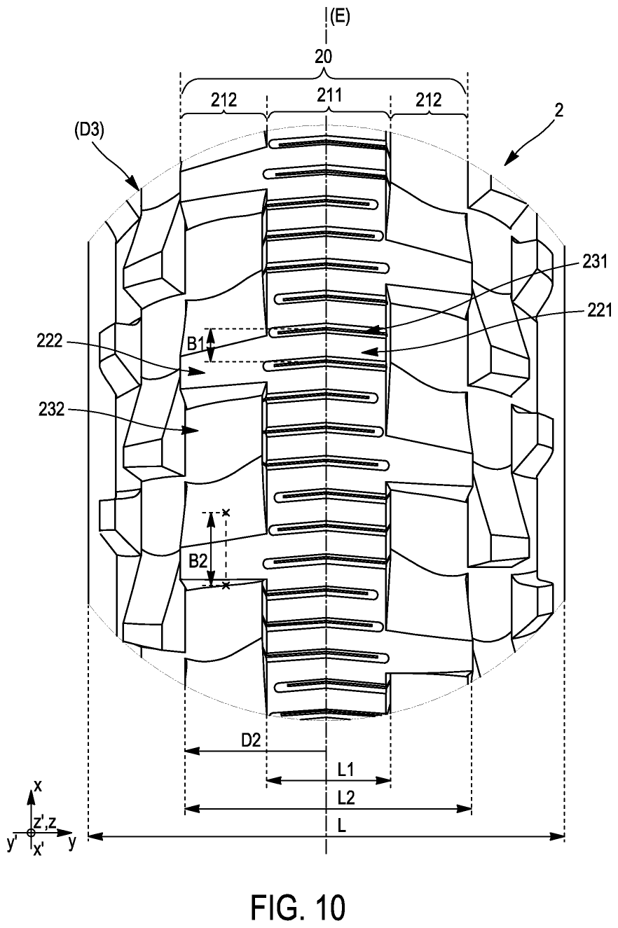

FIG. 10: Detailed perspective view of the tread of a tire for an agricultural vehicle according to the third embodiment variant of the invention (detail D3 from FIG. 9).

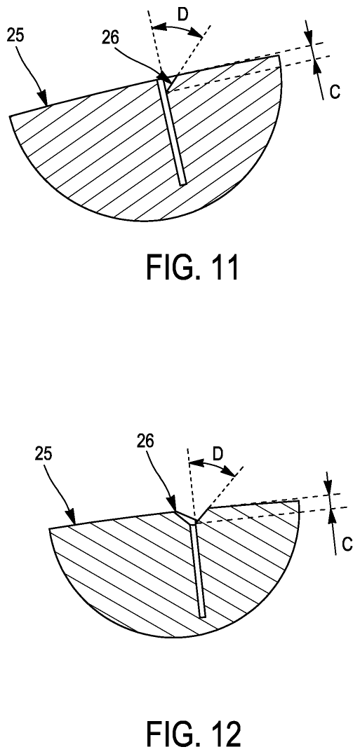

FIG. 11: View in section of a transverse void comprising a single chamfer.

FIG. 12: View in section of a transverse void comprising two facing chamfers.

FIGS. 1 to 5 illustrate a tire 1 for an agricultural vehicle according to a first embodiment variant of the invention. The tread 2 comprises tread pattern elements 22 that are separated from one another by voids 23 and extend radially outwards from a bearing surface 24 to a tread surface 25 (the bearing surface and the tread surface are shown in FIG. 6). In this first embodiment variant, the tread 2 comprises exclusively transverse voids 231 (FIGS. 2, 4 and 5). In the central tread portion 211, the transverse voids 231 are transverse sipes, of width I, that are able to close when they enter the contact patch in which contact is made with the ground when the tire is running (FIGS. 4 and 5), when the tire is subjected to pressure and load conditions as defined by the ETRTO standard. The tread pattern elements 221 of the central portion 211 of the tread, which are separated by said transverse sipes, have a mean radial height H and a mean circumferential length B (FIG. 5), and consequently a circumferential slenderness H/B.

FIG. 6 is a meridian half-section of a tire for an agricultural vehicle according to the invention. This radial section is made along the plane B-B of FIG. 3. This figure shows a tire 1 for an agricultural vehicle, having a nominal section half-width L/2 and comprising, radially from the outside to the inside, a tread 2 and a crown reinforcement 3. The tread 2 comprises tread pattern elements 22 that are separated from one another by voids 23 and extend radially outwards from a bearing surface 24 to a tread surface 25. The tread 2 has an overall volumetric void ratio TEV, defined as being the ratio between the volume VC of voids 23 and the total volume V of the tread 2 assumed to be free of voids, comprised between the bearing surface 24 and the tread surface 25, at least equal to 35%. Each tread pattern element 22 has a circumferential slenderness H/B at most equal to 0.8, H being the mean radial height between the bearing surface 24 and the tread surface 25 at least equal to 20 mm, and B being the mean circumferential length of the tread pattern element 22 (not shown). The crown reinforcement 3 comprises two crown layers 31, 32, each of which comprises mutually parallel, preferably metal, reinforcers that are coated with an elastomeric material, are crossed from one layer to the next, and form an angle at least equal to 10° with the circumferential direction XX′ of the tire. A carcass reinforcement 4 is positioned radially on the inside of the crown reinforcement 3. According to the invention, a central tread portion 211, centred on an equatorial plane E of the tire and having an axial width L1 at least equal to 0.15*L and at most equal to 0.35*L, comprises circumferentially distributed tread pattern elements 221 (identified by the generic reference 22 of the tread pattern elements, in FIG. 6), which are separated in pairs by transverse voids 231 (not shown in FIG. 6) forming an angle at least equal to 30° with the circumferential direction XX′, and the central tread portion 211 has a local volumetric void ratio TEVL1, defined as being the ratio between the volume VC1 of the transverse voids 231 and the total volume V1 of said central tread portion 211, comprised between the bearing surface 24 and the tread surface 25, at most equal to 15%. FIG. 6 shows a central tread half-portion of width L1/2. The tread 2 moreover comprises two intermediate portions 212, each axially continuing the central portion 211 outwards to an axial distance D2 equal to 0.3*L, measured from the equatorial plane E. FIG. 6 shows a single intermediate tread portion 212 of width D2-L1/2. With preference, a median tread portion 20 that is centred on the equatorial plane of the tire and has an axial width L2 equal to 2*D2=0.60*L, made up of the entirety of the central portion 211 and the two intermediate portions 212, has a local volumetric void ratio TEVL2, defined as being the ratio between the volume VC2 of the voids and the total volume V2 of said median tread portion 20, comprised between the bearing surface 24 and the tread surface 25, at most equal to 45%. FIG. 6 shows a median tread half-portion of width D2=L2/2.

FIGS. 7 and 8 illustrate a tire 1 for an agricultural vehicle according to a second embodiment variant of the invention as overall figure and figure of a detail C2, respectively. The tread 2 comprises tread pattern elements 22 that are separated from one another by voids 23. In this second embodiment variant, the tread 2 comprises a central portion 211, comprising circumferentially distributed tread pattern elements 221, which are separated from one another by voids 231 of transverse sipe type that are able to close when they enter the contact patch in which contact is made with the ground when the tire is running. Moreover, the central tread portion 211 is axially delimited on either side by circumferential voids 233.

FIGS. 9 and 10 illustrate a tire for an agricultural vehicle according to a third embodiment variant of the invention as overall figure and figure of a detail D3, respectively. In this third embodiment variant, the tread 2 of the tire of nominal section width L comprises a central portion 211 which is centred on an equatorial plane E of the tire and has an axial width L1 at least equal to 0.15*L and at most equal to 0.35*L, and two intermediate portions 212, each axially continuing the central portion 211 outwards to an axial distance D2 equal to 0.3*L, measured from the equatorial plane E. The assembly made up of the central portion 211 and the two intermediate portions 212 constitutes a median portion 20 which is centred on the equatorial plane E of the tire and has an axial width L2 equal to 2*D2=0.60*L. The central portion 211 comprises circumferentially distributed tread pattern elements 221, which are separated in pairs by transverse voids 231 forming an angle at least equal to 30° and, in the present case, at least equal to 60° with the circumferential direction XX′ of the tire. The transverse voids 231 of the central portion 211 are transverse sipes that are able to close when they enter the contact patch in which contact is made with the ground when the tire is running Each tread pattern element 221 has a circumferential slenderness H1/B1 at most equal to 1.5, H1 being a mean radial height between the bearing surface and the tread surface at least equal to 20 mm (not shown in FIGS. 8 and 9), and B1 being a mean circumferential length. B1 is measured at the tread surface, since the leading and trailing faces of the tread pattern elements 221 are substantially radial. According to the invention, the central portion 211 has a local volumetric void ratio TEVL1, defined as being the ratio between the volume VC1 of transverse voids 231 and the total volume V1 of said central portion 211, comprised between the bearing surface and the tread surface, at least equal to 15%. Each central portion 212 comprises circumferentially distributed tread pattern elements 222, which are separated in pairs by transverse voids 232 forming an angle at least equal to 30° and, in the present case, at least equal to 60° with the circumferential direction XX′ of the tire. Each tread pattern element 222 has a circumferential slenderness H2/B2 at most equal to 1.5, H2 being a mean radial height between the bearing surface and the tread surface at least equal to 20 mm (not shown in FIGS. 8 and 9), and B2 being a mean circumferential length. B2 is measured between two points situated substantially in the middle of the leading face and in the middle of the trailing face, respectively, in the knowledge that they exhibit an inclination referred to as taper with respect to a radial plane YZ. In the embodiment shown in FIGS. 9 and 10, the circumferential slenderness H1/B1 is strictly greater than the circumferential slenderness H2/B2, which itself is strictly less than 0.6. Lastly, the median portion 20 that is centred on the equatorial plane E of the tire and has an axial width L2 equal to 2*D2=0.60*L has a local volumetric void ratio TEVL2, defined as being the ratio between the volume VC2 of the voids and the total volume V2 of said median portion 20, comprised between the bearing surface and the tread surface, at most equal to 45%.

FIGS. 11 and 12 show a view in section of a transverse void comprising a single chamfer and a view in section of a transverse void comprising two facing chamfers, respectively. Each chamfer 26 opens out on the tread surface 25 with the formation of an angle D at least equal to 30° and at most equal to 70° with a radial direction and has a radial height C at least equal to 3 mm and at most equal to 10 mm.

The invention has been studied more particularly for a tire for an agricultural vehicle of size VF 600/70R30 165D, corresponding to an embodiment of the invention as shown in FIGS. 9 and 10 with circumferential elements of tread pattern elements that are different between the central portion and the intermediate portions.

Table 1 below shows the characteristics of the example studied by the inventors:

TABLE 1

| | Characteristic | | |
|---|---|---|---|
| Characteristics | values | | Comments |
| Nominal section width L | 600 | mm | |
| Overall volumetric void ratio | 48% | | At most equal to |
| TEV | | | 56% |
| Width L1 of central tread | 160 | mm | 27% of L, thus |
| portion | | | comprised between |
| | | | 15% and 35% of L |
| Local volumetric void ratio | 8% | | Less than 15% |
| TEVL1 of central portion | | | |
| Width L2 of median tread | 360 | mm | Equal to 60% of L |
| portion | | | |
| Local volumetric void ratio | 35% | | Less than 45% |
| TEVL2 of median portion | | | |
| Mean radial height H1 of a tread | 42 | mm | Comprised between |
| pattern element of the central | | | 20 mm and 55 mm |
| portion | | | |
| Mean circumferential length B1 | 41 | mm | |
| of a tread pattern element of | | | |
| the central portion | | | |
| Circumferential slenderness | 1.02 | | Less than 1.5 |
| H1/B1 of a tread pattern element | | | |
| of the central portion | | | |
| Mean radial height H2 of a tread | 37 | mm | Comprised between |
| pattern element of the | | | 20 mm and 55 mm |
| intermediate portion | | | |
| Mean circumferential length B2 | 110 | mm | |
| of a tread pattern element of the | | | |
| intermediate portion | | | |
| Circumferential slenderness | 0.34 | | Less than 0.6 |
| H2/B2 of a tread pattern element | | | |
| of the intermediate portion | | | |
| Width I of a sipe of the central | 2.7 | mm | Width making it |
| portion | | | possible for the sipe |
| | | | to close in the |
| | | | contact patch in the |
| | | | recommended |
| | | | running conditions. |
| Angle of a sipe of the central | 85° | | Greater than 60° |
| portion with respect to the | | | and thus greater |
| circumferential direction | | | than 30° |
| Angle D of a chamfer of a sipe | 45° | | Comprised between |
| of the central portion with | | | 30° and 70° |
| respect to a radial direction | | | |
| Radial height C of a chamfer of | 5 | mm | Comprised between |
| a sipe of the central portion | | | 3 mm and 10 mm |
| Mean width of a transverse sipe | 140 | mm | |
| (outside of the central portion) | | | |

| | | |
|---|---|---|
| Mean angle of a transverse void | 80° | Greater than 30° |
| (outside of the central portion) | | |
| with respect to the circumferential | | |
| direction | | |

The inventors have found that a tire according to the invention having the characteristics described in Table 1 confers a gain in traction of about 27% over a reference tire of the prior art for a low degree of slip on the ground of between 4% and 10%, that is to say is able to develop a traction force approximately 27% greater than that developed by a tire of the prior art.

1. A tire for an agricultural vehicle, having a nominal section width L and comprising, radially from the outside to the inside, a tread and a crown reinforcement;
the tread comprising tread pattern elements, which are separated from one another by voids and extend radially outwards from a bearing surface to a tread surface,
the tread having an overall volumetric void ratio TEV, defined as being the ratio between the volume VC of voids and the total volume V of the tread assumed to be free of voids, comprised between the bearing surface and the tread surface,
each tread pattern element having a circumferential slenderness H/B at most equal to 1.5, H being a mean radial height between the bearing surface and the tread surface at least equal to 20 mm, and B being a mean circumferential length,
the tread comprising a central portion, centred on an equatorial plane (E) of the tire and having an axial width L1 at least equal to 0.15*L and at most equal to 0.35*L, and two intermediate portions, each of which continues the central portion axially outwards to an axial distance D2 equal to 0.3*L, measured from the equatorial plane (E),
the central portion and each intermediate portion respectively being made up of a circumferential distribution of tread pattern elements, which are separated in pairs by transverse voids forming an angle at least equal to 30° with a circumferential direction (XX′) of the tire,
the crown reinforcement comprising at least two crown layers, each of which comprises mutually parallel reinforcers that are coated with an elastomeric material, are crossed from one layer to the next, and form an angle at least equal to 10° with the circumferential direction (XX′),
wherein the central portion has a local volumetric void ratio TEVL1, defined as being the ratio between the volume VC1 of the transverse voids and the total volume V1 of said central portion, comprised between the bearing surface and the tread surface, at most equal to 15%.

2. The tire according to claim 1, wherein the transverse voids of the central portion form an angle at least equal to 60° with the circumferential direction (XX′).

3. The tire according to claim 1, wherein the transverse voids of the central portion are transverse sipes that are able to close when they enter the contact patch in which contact is made with the ground when the tire is running.

4. The tire according to claim 1, wherein the transverse voids of each intermediate portion form an angle at least equal to 60° with the circumferential direction (XX′).

5. The tire according to claim 1, wherein each tread pattern element of the central portion has a mean radial height H1, a mean circumferential length B1, and a circumferential slenderness H1/B1, and each tread pattern element of each intermediate portion has a mean radial height H2, a mean circumferential length B2, and a circumferential slenderness H2/B2, and wherein the circumferential slenderness H1/B1 is strictly greater than the circumferential slenderness H2/B2.

6. The tire according to claim 5, wherein the circumferential slenderness H2/B2 of each tread pattern element of each intermediate portion is at most equal to 0.6.

7. The tire according to claim 1, wherein a median portion that is centred on the equatorial plane (E) of the tire and has an axial width L2 equal to 2*D2=0.60*L has a local volumetric void ratio TEVL2, defined as being the ratio between the volume VC2 of the voids and the total volume V2 of said median portion, comprised between the bearing surface and the tread surface, at most equal to 45%.

8. The tire according to claim 1, wherein the tread comprises exclusively transverse voids.

9. The tire according to claim 1, wherein the central portion is axially delimited on either side by circumferential voids.

10. The tire according to claim 1, wherein each tread pattern element has a mean radial height H at most equal to 55 mm.

11. The tire according to claim 1, wherein the tread has an overall volumetric void ratio TEV at most equal to 56%.

12. The tire according to claim 1, wherein at least some of the tread pattern elements comprise at least one chamfer which opens out on the tread surface with the formation of an angle D at least equal to 30° and at most equal to 70° with a radial direction (ZZ′) and has a radial height C at least equal to 3 mm and at most equal to 10 mm.

13. The tire according to claim 1, wherein the crown reinforcement comprises crown layers comprising metal reinforcers, preferably at most two crown layers comprising metal reinforcers.

14. The tire according to claim 1, wherein the tire for an agricultural vehicle is an “IF”, or “Improved Flexion”, tire within the meaning of the standard of the “ETRTO”, or “European Tire and Rim Technical Organisation”, in its “Standards Manual-2018”, in the section devoted to “Agricultural equipment tires”.

15. The tire according to claim 1, wherein the tire for an agricultural vehicle is a “VF”, or “Very high Flexion”, tire within the meaning of the standard of the “ETRTO”, or “European Tire and Rim Technical Organisation”, in its “Standards Manual-2018”, in the section devoted to “Agricultural equipment tires”.
